(19) United States
(12) Patent Application Publication
(10) Pub. No.: US 2014/0047723 A1
(43) Pub. Date: Feb. 20, 2014

(54) MOUNTED RECIPROCAL TRACKING GUIDE FOR POWERED CUTTING TOOLS

(71) Applicant: National Institute of Higher Education Research Science and Technology, St. Augustine (TT)

(72) Inventor: Maurice Peter VIDALE WADE, Santa Cruz (TT)

(73) Assignee: National Institute of Higher Education Research Science and Technology, St. Augustine (TT)

(21) Appl. No.: 13/966,597

(22) Filed: Aug. 14, 2013

Related U.S. Application Data
(60) Provisional application No. 61/742,550, filed on Aug. 14, 2012.

(51) Int. Cl. B27B 17/00

(52) U.S. Cl. CPC B27B 17/0083
USPC 30/383; 83/821; 83/33

(57) ABSTRACT

An attachment for a cutting tool includes a tracking guide configured to interface with an object to be cut. The tracking guide may be inserted into a groove formed by the cutting tool in an already cut portion of the object such that positioning of the tracking guide in the groove guides further progress of the cutting tool.

### CROSS-REFERENCE TO RELATED APPLICATIONS

This application claims priority to U.S. Provisional Application Ser. No. 61/742,550, filed Aug. 14, 2012, which is incorporated herein by reference in its entirety.

### TECHNICAL FIELD

The present technology relates generally to cutting tools, and more particularly to devices for guiding the advancement of cutting tools.

### BACKGROUND

Logs from felled trees are often transported to a mill where the logs are processed by cutting machines and converted into lumber having a variety of sizes and shapes. However, in some situations, sufficient access to the forest so as to transport logs away from the forest does not exist. Moreover, the work area in the forest often lacks adequate power means to sustain a miniature mill facility in the forest.

A variety of methods and equipment, including chainsaws fixed in various attachments, have been employed to cut raw logs into planar boards (known as “boarding”) in-situ on the forest floor. However, these methods and devices have a number of drawbacks, such as limitations in their dimensional capacity, complexity of assembly and deployment, and requirement for external appendages.

One known method of cutting raw logs into planar boards is shown in FIGS. 3-7. First, as shown in FIG. 3, guide board 70 is firmly attached to an uppermost surface of log 22, for example by nailing the guide board to the log. Next, a saw attachment (not shown) is clamped to the chainsaw bar. The chainsaw is then oriented so that the chainsaw bar extends horizontally to make a first top-flat cut 72. The saw attachment is configured to slide along the top surface of the guide board to guide the chainsaw while holding the chainsaw at an adjustable depth from guide board 70.

The top-flat 71 established by this initial cut is then employed to guide the saw attachment in executing a straight and level bottom flat-cut 74 near a bottom surface of log 22, as shown in FIG. 4.

Log 22 is then rotated 90° and then guide board 70 is used to make a second top-flat cut 76, as shown in FIG. 6. This newly created top-flat surface is then used to guide the saw attachment in sawing the now squared log into boards 78, as shown in FIG. 7.

### SUMMARY

One exemplary attachment for a cutting tool includes a tracking guide which traverses along a groove cut into an object by a cutting member of the cutting tool while reciprocally guiding progress of the cutting member.

The exemplary attachment may guide progress of the cutting member along a line formed by the linear extension of the groove formed in the already cut portion of the object.

An exemplary attachment for a cutting tool may include a support member configured to be attached to the cutting tool and a tracking guide coupled to the support member. The tracking guide, in a front view, is arranged to extend in horizontal alignment with the cutting member such that the tracking guide is configured to be inserted into a groove formed by the cutting member in an already cut portion of the object. Positioning of the tracking guide in the groove reciprocally guides progress of the cutting member.

In an exemplary method, the cutting tool may be operated to form a groove in the object. The tracking guide may then be inserted into the groove. Next, a through-cut may formed in the object such that positioning of the tracking guide in the groove while performing the through-cut guides progress of the cutting member during the through-cut.

In an exemplary method, the cutting tool may be operated to cut the object with the cutting member thereby forming a groove in the object. Next, the tracking guide may be inserted into the groove such that movement of the tracking guide within the confines of the groove reciprocally guides advancement of the cutting member.

An exemplary cutting tool is configured to mill felled trees into boards (e.g., planks, slabs, beams) while accommodating any positioning of the felled trees on the forest floor.

An exemplary cutting tool is configured to cut an object into boards having straight, consistent profiles without use of a traditional guide board.

Other aspects, features, and advantages of this technology will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this technology. In such drawings:

FIG. 1a is a perspective view of an example cutting tool;

FIG. 1b is a front view of the cutting tool of FIG. 1a;

FIG. 2-1 is a perspective view of an example cutting guide of the cutting tool of FIG. 1a;

FIG. 2-1a is a front view of the cutting guide of FIG. 2-1;

FIG. 2-1b is a side view of the cutting guide of FIG. 2-1;

FIG. 2-2 is a perspective view of an example cutting guide of the cutting tool of FIG. 1a;

FIGS. 3-7 show a conventional sequence of cutting a log into boards;

FIGS. 8-10 show an example process of cutting a log into boards according to the present disclosure;

FIG. 11a is a perspective view of an example cutting process;

FIG. 11b is a perspective view similar to FIG. 11a showing a cutaway portion of the log;

FIG. 11c illustrates various steps in the cutting process of FIG. 11a;

FIG. 12a is a perspective view of another example cutting process;

FIG. 12b is a perspective view similar to FIG. 12a showing a cutaway portion of the log;

FIG. 13a is a perspective view of another example cutting process;

FIG. 13b is a perspective view of a step in the cutting process of FIG. 13a;

FIG. 13c is a perspective view of a step in the cutting process of FIG. 13a showing a cutaway portion of the log;

FIG. 14a is a perspective view of another example cutting process; and

FIG. 14b is a perspective view of a step in the cutting process of FIG. 14a.

### DETAILED DESCRIPTION OF ILLUSTRATED EXAMPLES

The following description is provided in relation to several examples (most of which are illustrated) which may share some common characteristics and features. It is to be understood that one or more features of any one example may be combinable with one or more features of the other examples. In addition, any single feature or combination of features in any of the examples may constitute additional examples.

### 1.0 Cutting Tool Assembly

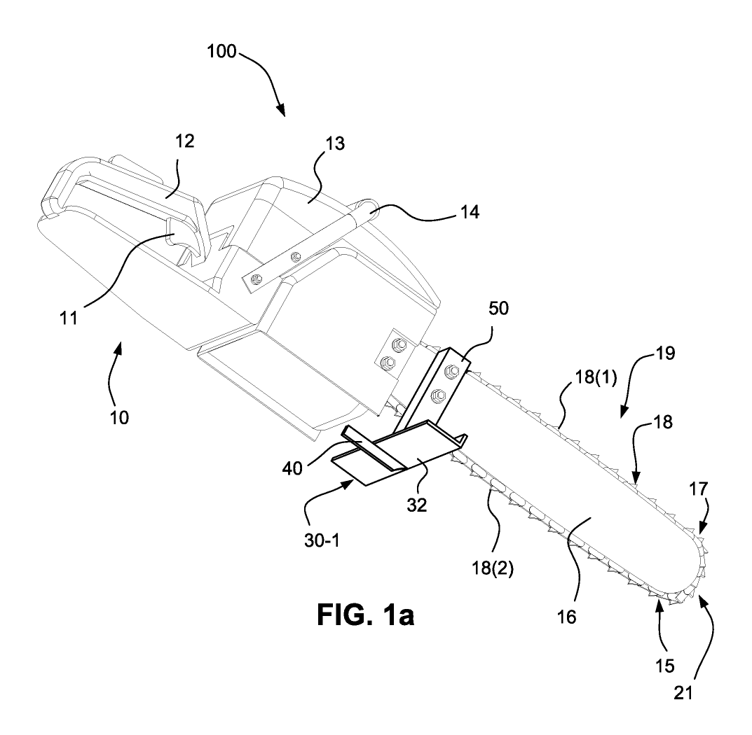

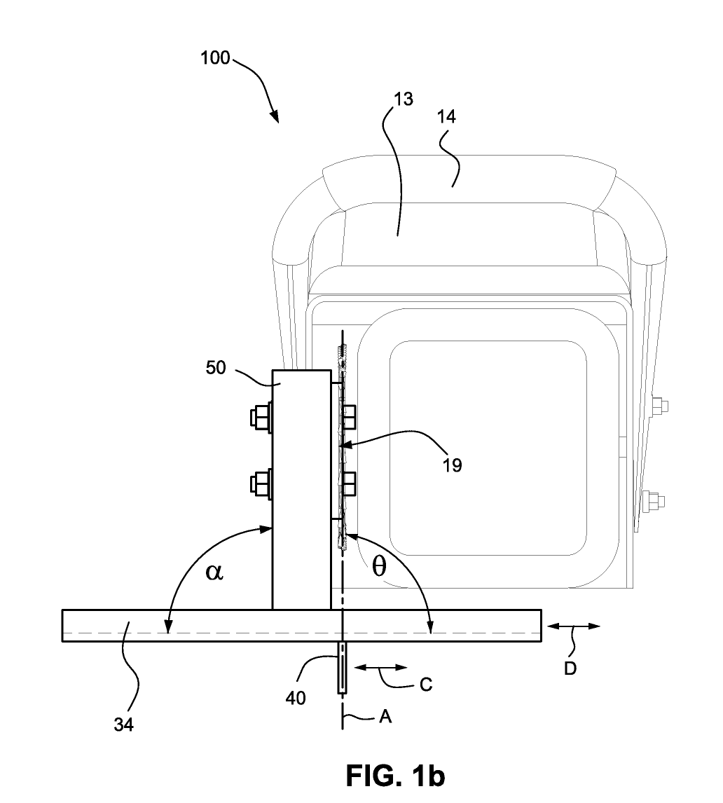

The disclosed technology can be employed in a variety of cutting tools (e.g. jigsaws, chainsaws, saber-saws, linear reciprocating saws, routers, etc.). The illustrated example, however, is directed to a chainsaw. Referring to FIG. 1a, a chainsaw-cutting guide assembly 100 is shown. Chainsaw-cutting guide assembly 100 includes a chainsaw 10 having cutting guide 30-1 mounted thereon.

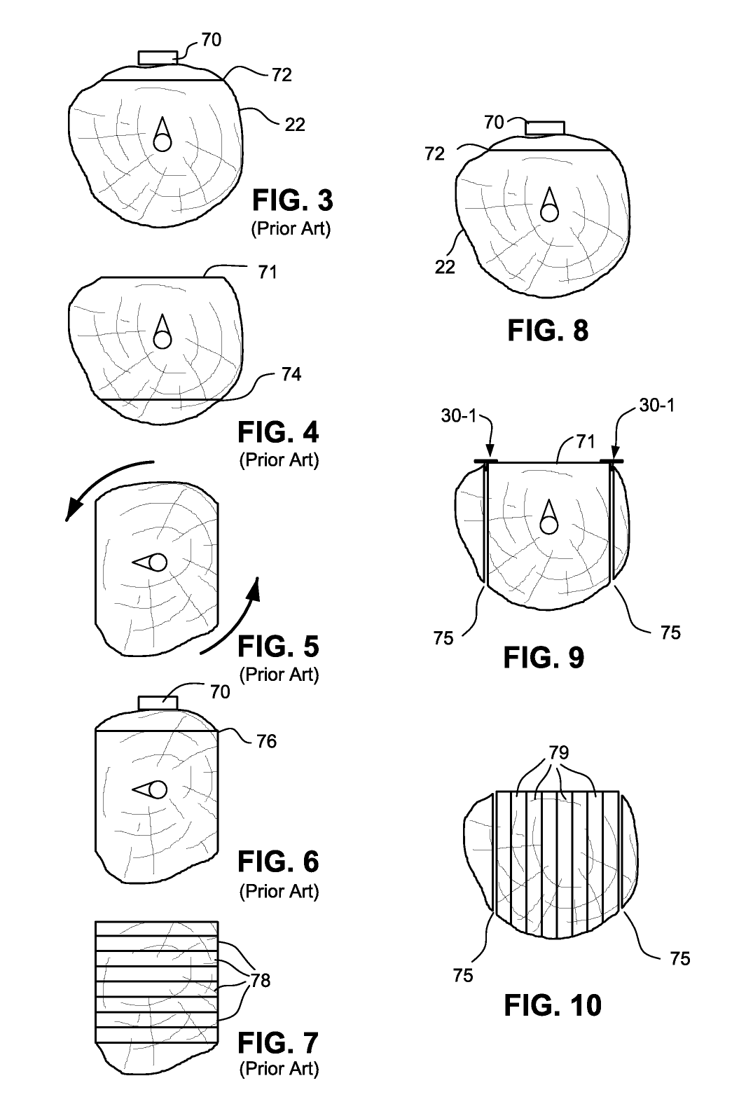

In an example method of the disclosure, an object to be cut (e.g., log 22) may be cut into uniformly straight and parallel boards 79, as shown in FIGS. 8-10, without the need to rotate log 22. That is, once top-flat 71 is formed with use of guide board 70, cutting guide 30-1 may be used to guide a cutting tool in performing a series of vertical cuts to create side-flats 75 and then planar boards 79 from log 22. In an alternative example, the conventional saw attachment described in connection with FIGS. 3-7 may be used to horizontally cut log 22 into boards 79 after side flats 75 are formed.

Referring to FIG. 1a, chainsaw 10 includes a cutting member 19 in the form of a chainsaw bar 16 having a saw chain 18 mounted thereon. Cutting member 19 includes a tip portion 21 having a bottom portion 15 and a top portion 17. Saw chain 18 includes an upper portion 18(1) and a lower portion 18(2).

An operator may grip chainsaw 10 by top handle 14 and rear handle 12. Power source (e.g., motor) 13 drives saw chain 18 around chainsaw bar 16. Trigger 11 may be used to adjust the speed of chain 18.

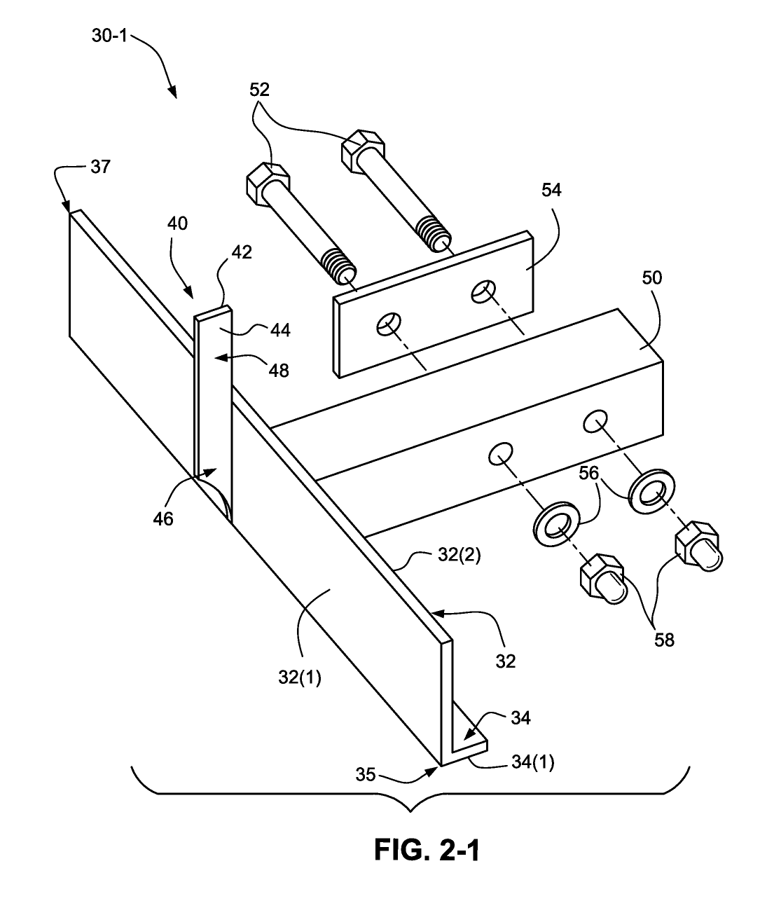

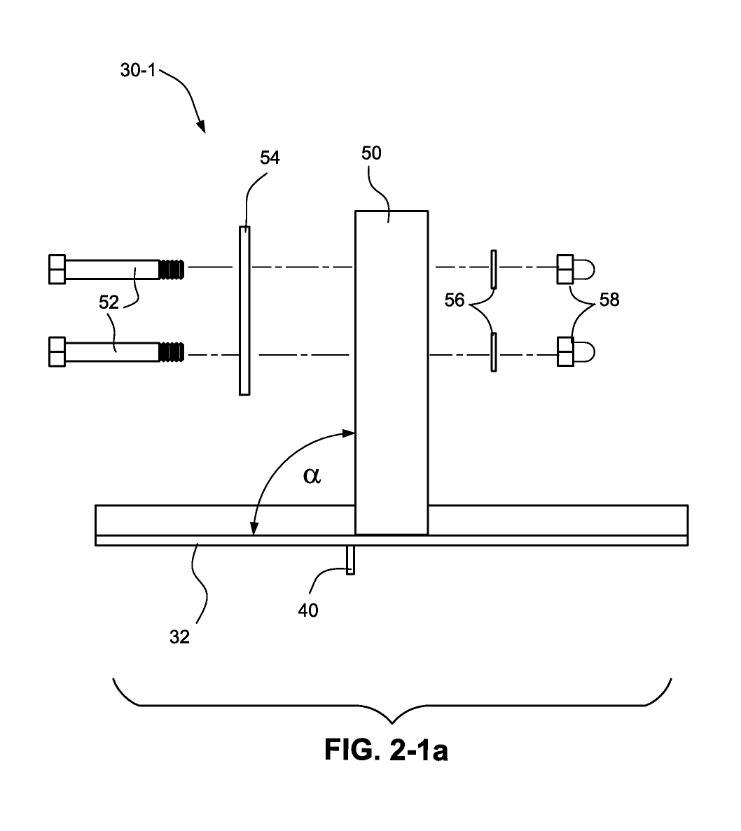

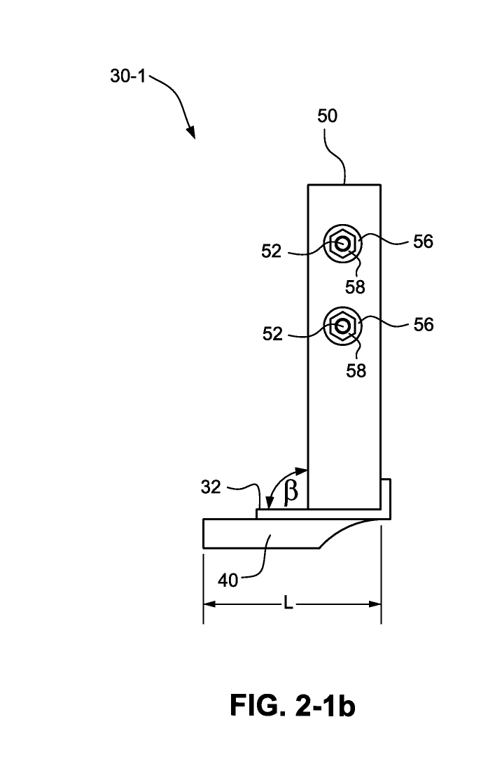

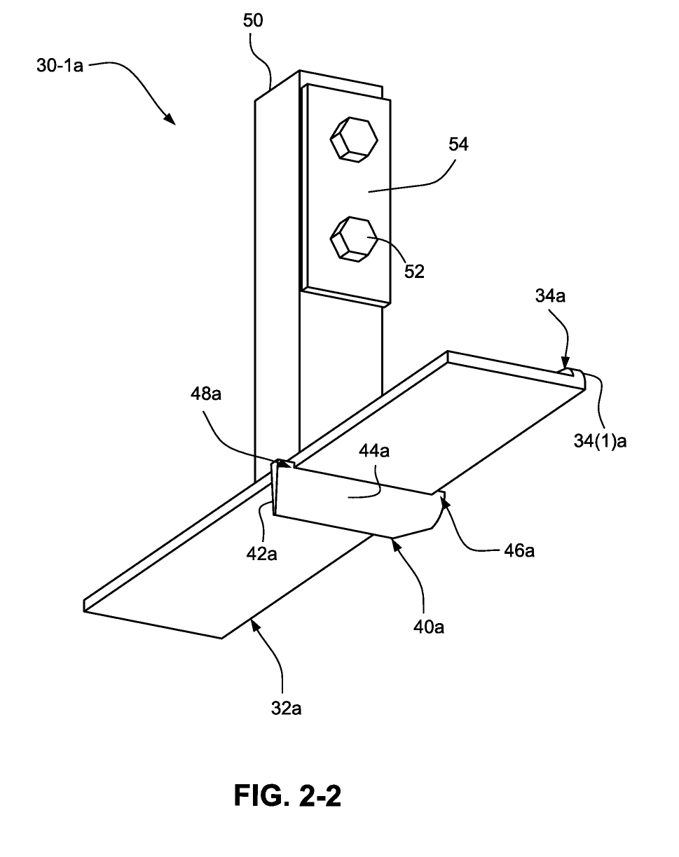

Cutting guide 30-1 includes a support member (or mount) 50, a stabilizing bar 32 connected to mount 50 and a tracking guide 40 protruding from stabilizing bar 32, as shown in FIG. 2-1. Cutting guide 30-1 also includes a wall 34 connected at an angle to stabilizing bar 32. Wall 34 includes an outer surface 34(1). Stabilizing bar 32 includes a bottom surface 32(1) from which tracking guide 40 extends and a top surface 32(2) from which mount 50 extends.

Mount 50 extends upwardly from stabilizing bar 32 at mounting angle α, as shown in FIGS. 1b, 2-1 and 2-1a. It is noted that since mount 50 extends upwardly in parallel to chainsaw bar 16, cutting member 19 extends at cutting angle θ with respect to stabilizing bar 32 which is equal to mounting angle α. Since stabilizing bar 32 is intended to lie flat against a surface to be cut, the angle formed between cutting member 19 and stabilizing bar 32 also determines the angle at which cutting member 19 cuts into the object. As mentioned, in the illustrated example of FIG. 1b, the angle between mount 50 and stabilizing bar 32 is the same as the angle between cutting member 19 and stabilizing bar 32. However, those skilled in the art will recognize that these angles may differ and that the cutting angle may be influenced by the orientation of mount 50 but is ultimately determined by the angle between cutting member 19 and stabilizing bar 32. In the examples shown in this disclosure, mounting angle α and cutting angle θ are 90° to facilitate the production of planar boards.

Mount 50 also forms tilt angle β with stabilizing bar 32, as shown in FIG. 2-1b. Angle θ essentially relates to a tilt of stabilizing bar 32. Since stabilizing bar 32 in intended to rest against a surface (e.g., a flat surface) of an object to be cut, as will be described later, tilt angle β may determine an incline at which the cutting member 19 engages the object as those skilled in the art will understand. It will be appreciated that stabilizing bar 32 may be connected to mount 50 in an adjustable manner so as to adjust, for example, mounting angle α, cutting angle θ, tilt angle β, and a distance between stabilizing bar 32 and cutting member 19 (or a length of mount 50).

Referring to FIG. 2-1, cutting guide 30-1 may include fulcrums 35, 37, for example, along edges of stabilizing bar 32. During operation, chainsaw 10 may be tilted into or out of the object to be cut by rotating the chainsaw about the fulcrums. It is noted that mount 50 may be attached to either side of cutting member 19 and thus either fulcrum 35 or fulcrum 37 may be presented as the forward edge (toward cutting member tip portion 21) and therefore the operative fulcrum.

Referring to FIG. 2-1, tracking guide 40 extends, preferably, perpendicularly from bottom surface 32(1), although the tracking guide may extend at other angles. It will be appreciated that tracking guide 40 may be connected to stabilizing bar 32 in an adjustable manner. Also, tracking guide 40 preferably forms a linear extension along bottom surface 32(1) although other configurations are possible (e.g., a curved shaped configured to abut against both sides of a linear groove in the object to be cut). The tracking guide includes sidewalls 42, 44 and a rear portion 48 which extends beyond bottom surface 32(1). Front portion 46 includes a sloping configuration or arc shape. Since front and rear portions 46, 48 are asymmetrical versatility of the assembly may be enhanced by reversible mounting to either side of cutting member 19.

As shown in FIG. 1b, tracking guide 40 may be in horizontal alignment with cutting member 19 such that both tracking guide 40 and cutting member 19 extend in plane A. By this arrangement, tracking guide 40 is intended to traverse along a groove formed in the object to be cut so as to guide the location of the cutting member with respect to the object to be cut. A shown in FIG. 2-1b, tracking guide 40 may have a length L. Generally, length L is a suitable distance to provide adequate resistance to deviation from linear movement when the tracking guide traverses along a groove formed in the object.

In another example, tracking guide 40 may be adjustably mounted (in the directions of arrows C in FIG. 1b) to stabilizing bar 32 so as to be positioned laterally offset in relation to cutting member 19 (so as to be positioned in a plane which is parallel to plane A of cutting member 19). By this arrangement, tracking guide 40 may be arranged to follow along in continuous contact with a previously cut outer vertical flat surface of log 22 to guide cutting member 19 is making a cut parallel to the outer surface. Also, tracking guide 40 may be positioned in a previously formed groove (e.g., formed by saw cut 82 as described later) to guide cutting member 19 in making a cut parallel to the groove. It is noted that tracking guide 40 may be adjusted through an adjustable connection between stabilizing bar 32 and mount 50 (allowing adjustment of stabilizing bar 32 in the directions of arrows D in FIG. 1b).

Referring to FIG. 2-1, rear portion 46 of tracking guide 40 may enable the tracking guide to remain at least partially inserted in the groove formed in the object to be cut when the cutting guide 30-1 is tilted about fulcrum 37.

Cutting guide 30-1 may be mounted to chainsaw bar 16 by a connector (e.g., bolts 52, washers 56, locking nuts 58), as shown in FIGS. 1a, 1b and 2-1. It will be appreciated that other connectors or ways of connecting cutting guide 30-1 to chainsaw bar 16 may be used. In the illustrated example, bolts 52 are passed through holes in support mount 50 and holes in cutting member 19. A spacer 54 may be installed between mount 50 and cutting member 19 to space saw chain 18 from mount 50 so as to prevent mount 50 from interfering with movement of saw chain 18. It is noted that mount 50 may be adjustably connected to chainsaw 10.

It will also be appreciated that cutting guide 30-1 may be mounted to another portion of chainsaw 10 aside from chainsaw bar 16, such as a casing or housing of chainsaw 10.

Cutting guide 30-1 may be constructed, in whole or in part, from a variety of materials including, for example, various metals/alloys, plastics, wood and synthetic composites.

In another example shown in FIG. 2-2, a cutting guide 30-1a includes a tracking guide 40a which has a wedge shape formed by sidewalls 42a, 44a. The wedge shape may facilitate insertion of the tracking guide into a groove in an object to be cut. Further, tracking guide 40a may include asymmetrical front and rear portions 46a, 48a which extend beyond stabilizing bar 32a to facilitate tilting of the cutting guide 30-1a, as described earlier. A wall 34a is connected to stabilizing bar 32 and has an outer surface 34(1)a.

### 2.0 Operation

Operation of the cutting tool assembly will now be described in accordance with exemplary methods of the disclosure. It is noted that the location of the cut to more or less the center of log 22 has been chosen for ease of illustration.

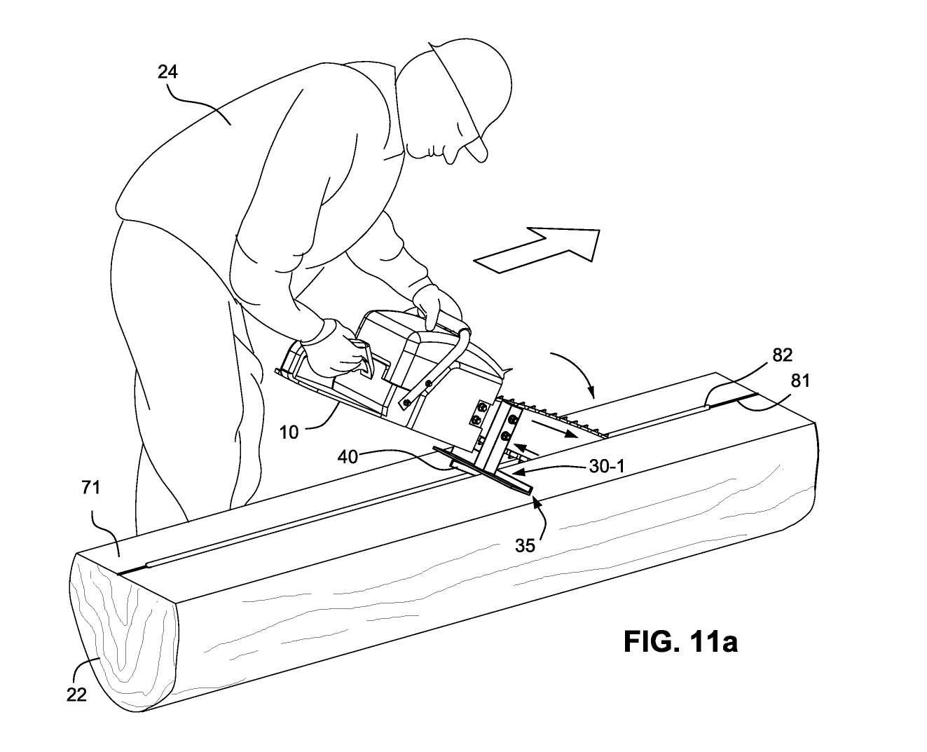

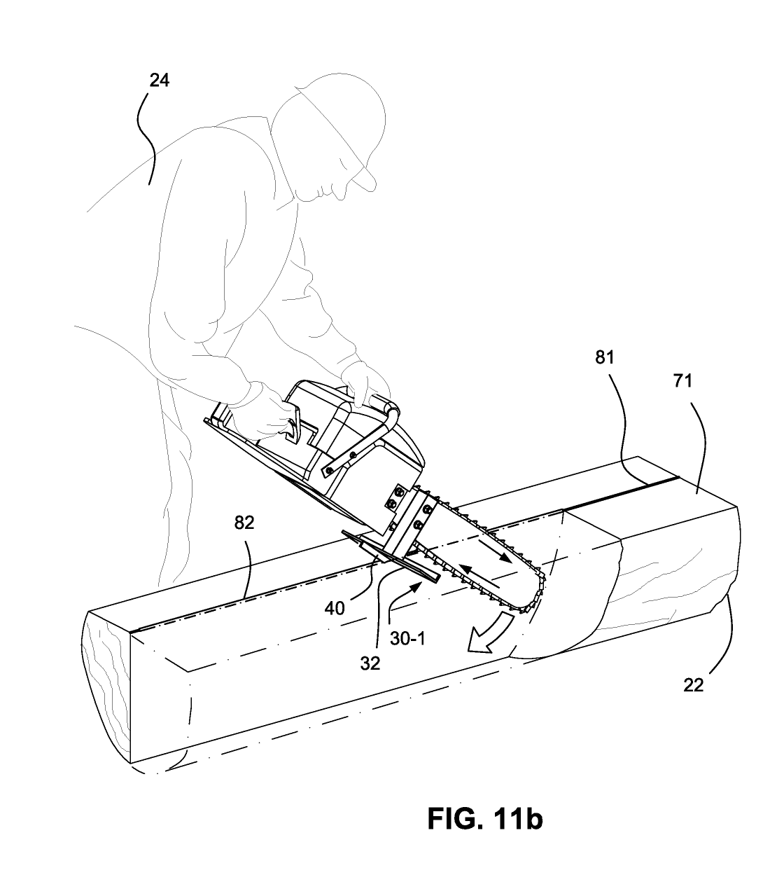

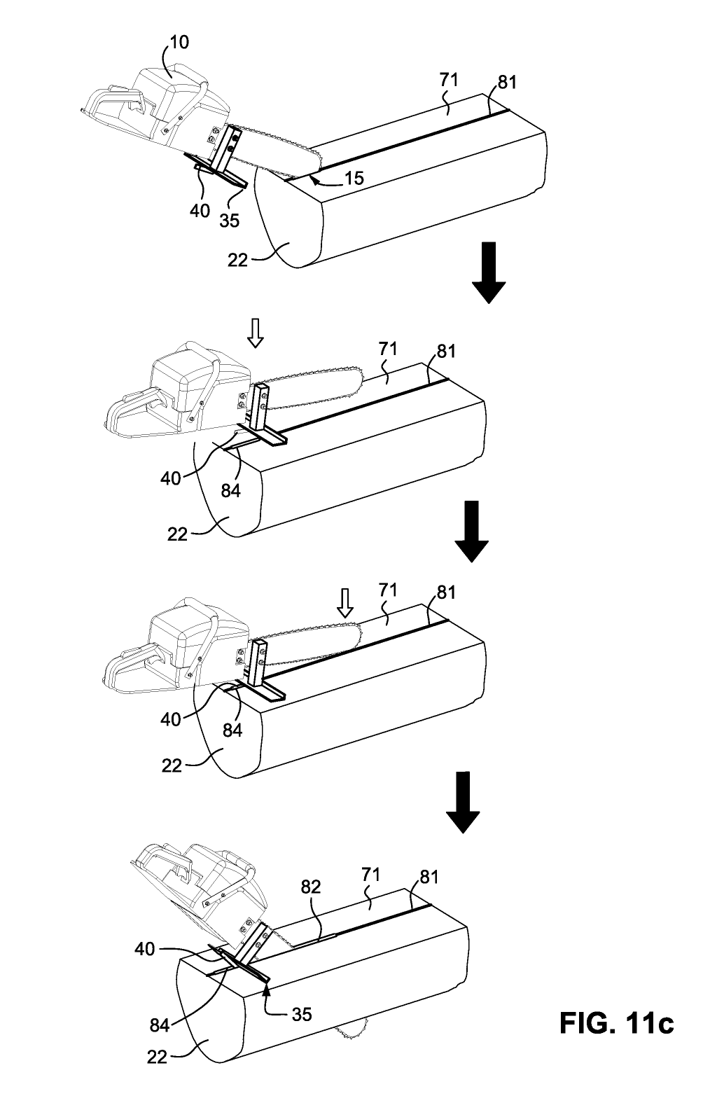

In an example shown in FIGS. 11a to 11c, a step-wise method of performing a vertical cut in log 22 is illustrated. FIG. 11a shows an operator 24 near the final stage of the cutting operation. FIG. 11b is similar to FIG. 11a but shows a cutaway portion of log 22.

FIG. 11c illustrates the steps by which this cutting operation is performed. The location along top-flat 71 of the intended vertical cut may be marked by a chalk/pencil line 81 (or other similar process). First, the bottom portion 15 of cutting member tip 21 is used to create a shallow groove 84 at a desired location along chalk line 81. It is noted that the log 22 may not be initially cut through completely at its ends so as to preserve the straight and flat shape of the boards during initial drying/curing period, as those skilled the art will understand.

The tracking guide 40 is then positioned into shallow groove 84 while stabilizing bar 32 is positioned to lie (e.g., flat) against top-flat 71. Positioning of tracking guide 40 in shallow groove 84 will hold cutting member 19 in rectilinear alignment along the intended cut line. Next, cutting member 19 is pivoted about fulcrum 35 to create saw cut 82. The cutting action is performed by the lower portion 18(2) of saw chain 18. Further tilting of chainsaw 10 continues an arc-shaped cut into log 22. Once a first segment of saw cut 82 has been completed (e.g., to more or less a vertical of its arc), cutting member 19 is removed from saw cut 82. Saw cut 82 forms a groove in log 22 which can be used to receive tracking guide 40 at a position further along log 22.

Chainsaw 10 is advanced to a position forward of its original position with tracking guide 40 continuously engaged in the groove formed by saw cut 82, and then, a second arc-shaped cut is formed. In another example, chainsaw 10 may be advanced by removing tracking guide 40 from the groove and then re-inserting tracking guide 40 at a position forward of its original position. Preferably, the second arc-shaped cut will overlap the first cut near the vertical radius of the second cut in order to effect continuous cut-through of saw cut 82. This procedure may be repeated as necessary to cut a desired length of log 22. As can be seen, the cutting operation progresses away from the operator 24.

It is noted that tracking guide 40 is constrained to follow along the line of the groove formed by cutting member 19 while reciprocally guiding the cutting member to maintain progress faithfully along a line projected from the already cut portion of log. 22.

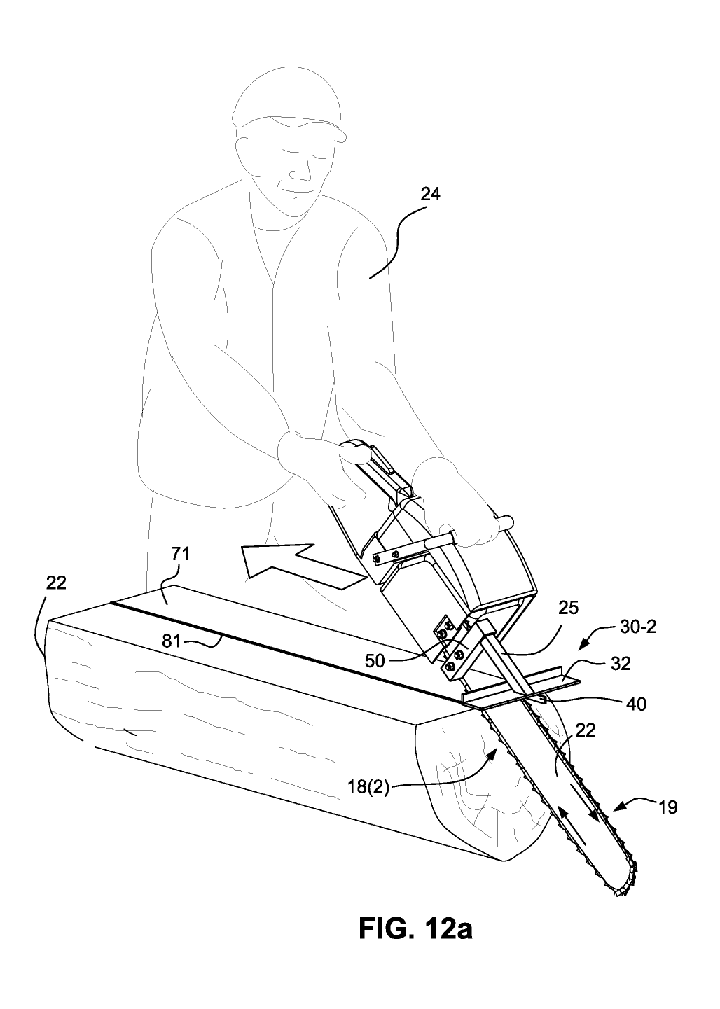

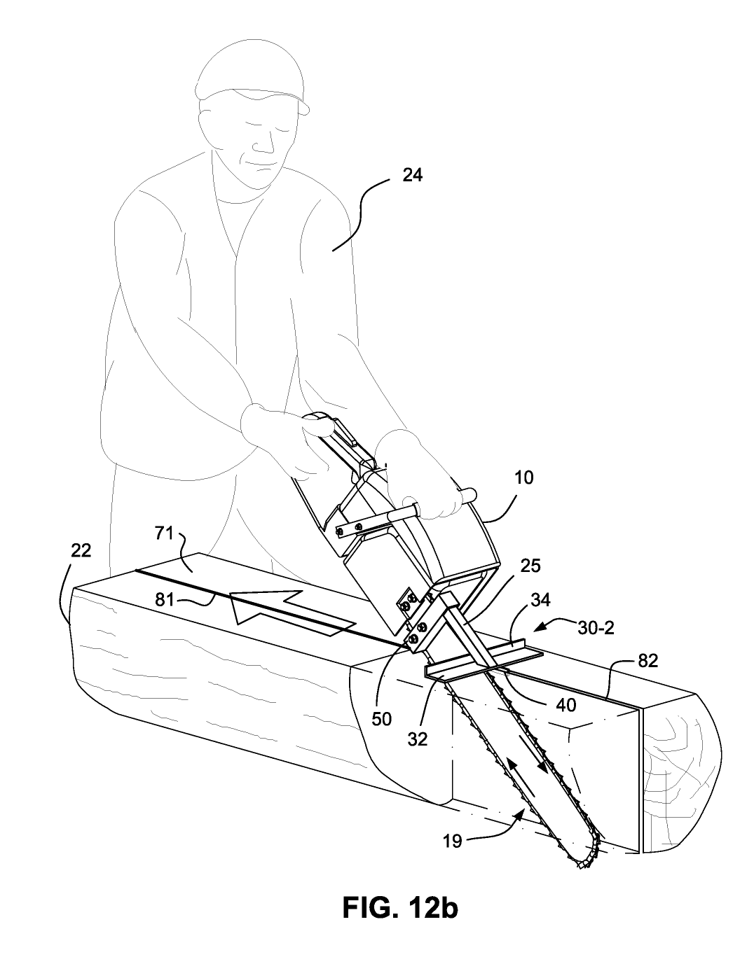

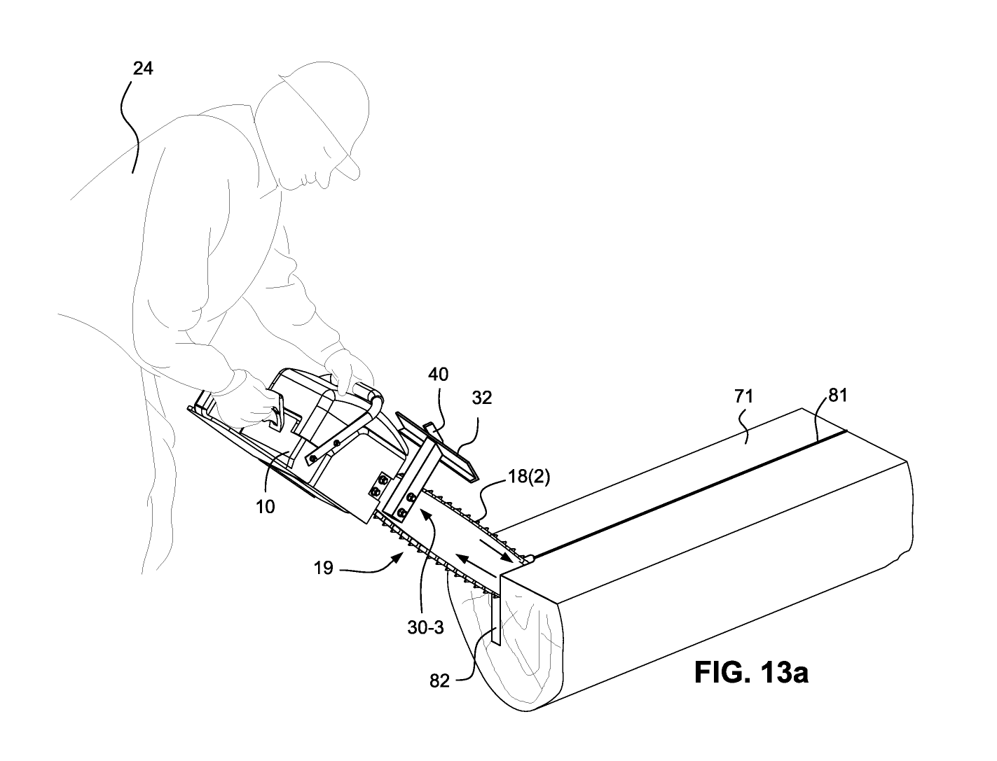

Another example cutting procedure is shown in FIGS. 12a and 12b using cutting guide 30-2. In this example, log 22 is continuously cut by cutting member 19, instead of the step-wise process of FIGS. 11a to 11c. This process also significantly reduces the hazard of kick-back during operation. Also, cutting guide 30-2 is mounted above cutting member 19 in contrast to cutting member 30-1 described earlier which is mounted below cutting member 19. An extension leg 25 connects mount 50 to stabilizing bar 32.

As shown in FIG. 12a, lower portion 18(2) of the saw chain is brought into contact with log 22 along chalk line 81. Eventually, tracking guide 40 will enter the groove just previously formed by saw cut 82, as shown in FIG. 12b. The tracking guide 40 is compelled to follow along the groove just previously formed by saw cut 82 (which is e.g., a true straight line by process of following chalk line 81) and in reciprocal fashion, the tracking guide simultaneously compels cutting member 19 to maintain progress along a true straight line projected from the already cut portion of log 22.

As is seen in FIGS. 12a and 12b, the cutting operation progresses towards operator 24.

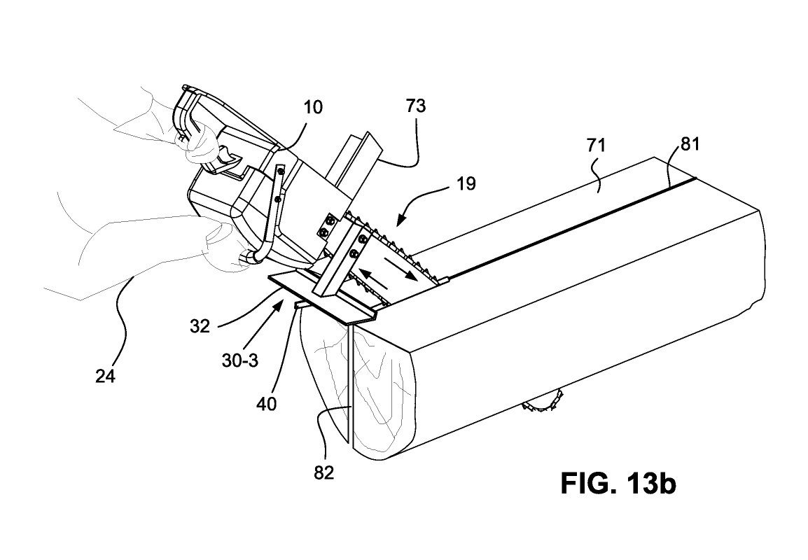

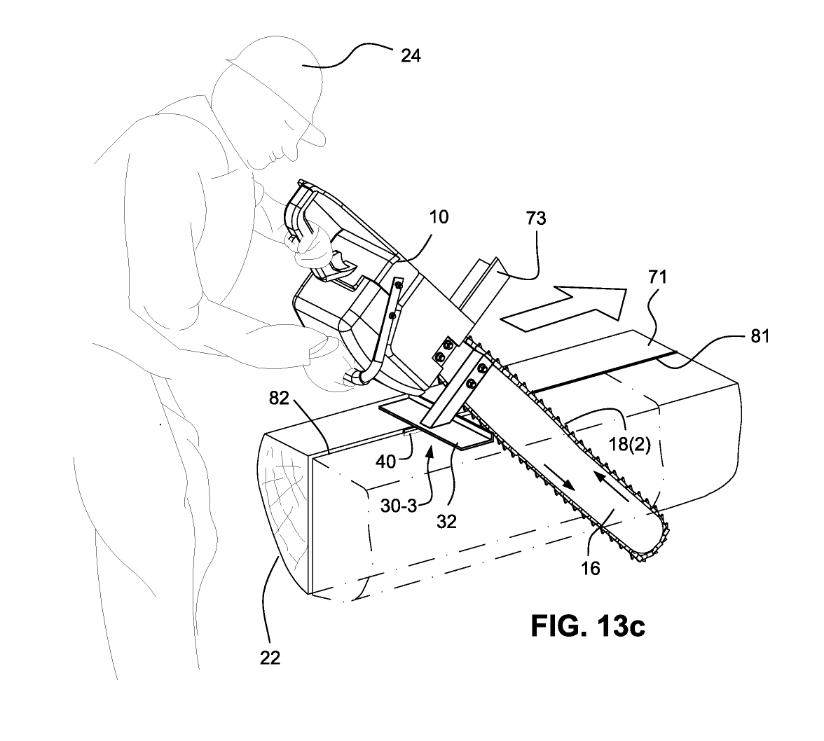

In the example shown in FIGS. 13a to 13c, chainsaw 10 is first operated in a right-side-up orientation to initiate saw cut 82 in an end of log 22. Cutting guide 30-3 is mounted above cutting member 19. Chainsaw 10 is then inverted to function in an upside-down orientation and log 22 is further cut in a continuous process, as shown in FIGS. 13b and 13c. Tracking guide 40 is positioned in the groove just previously formed by saw cut 82 and guides cutting member 19 is a manner similar to FIGS. 12a and 12b described above.

This process also significantly reduces the hazard of kick-back during operation. In contrast to the example of FIGS. 12a and 12b, the cutting operation progresses away from the operator 24. As shown in FIGS. 13b and 13c, guard 73 may be attached to chainsaw 10 to prevent sawdust from contacting the operator.

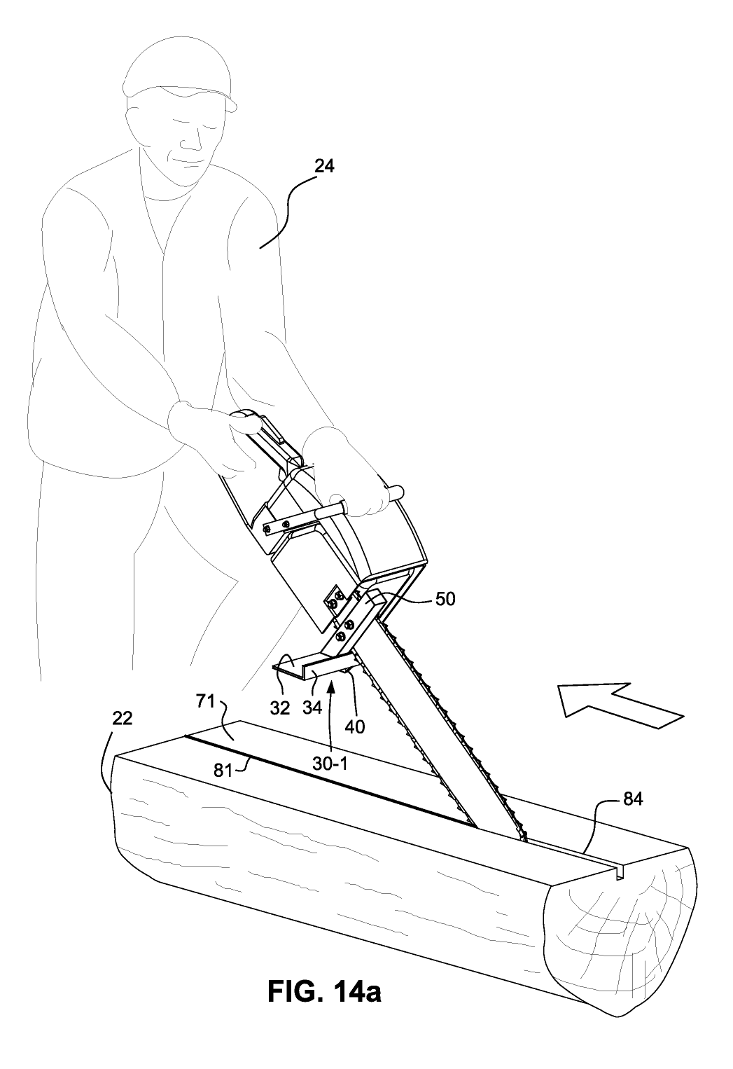

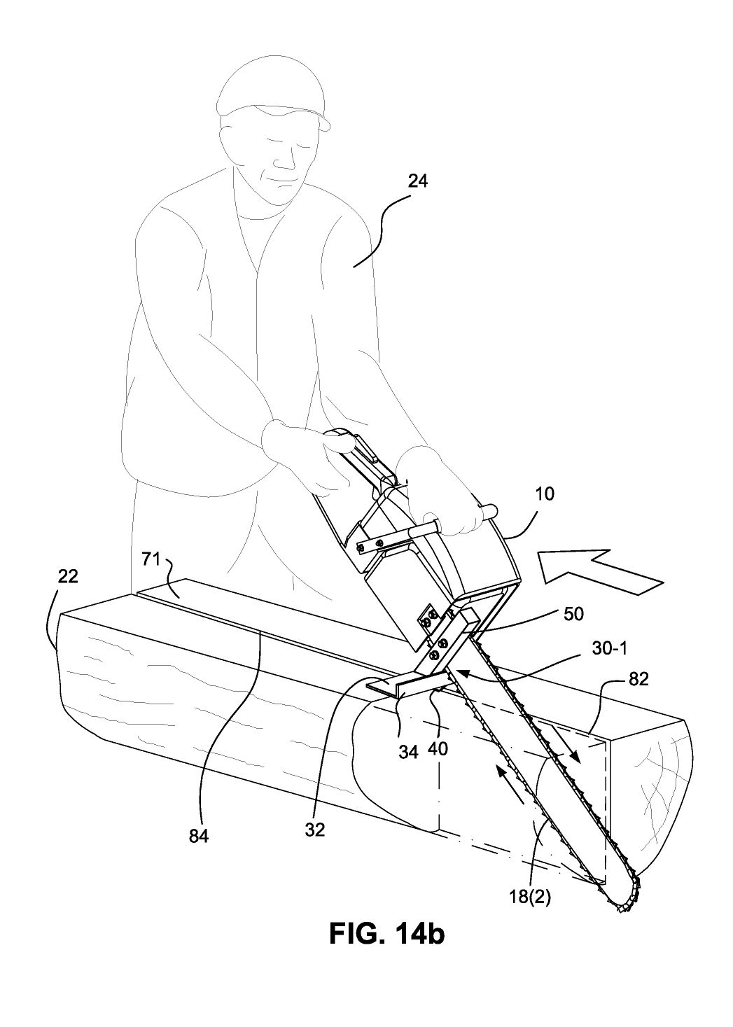

In another example shown in FIGS. 14a and 14b, chainsaw 10 may be initially operated to create a shallow groove 84 along chalk line 81. As shown in FIG. 14a, cutting guide 30-1 is mounted below cutting member 19 and mount 50 forms an angle β (see FIG. 2-1b) other than 90°. After shallow groove 84 is formed, chainsaw 10 is then engaged to perform a through-cut in log 22 at the same location of shallow groove 84. Tracking guide 40 is positioned to traverse along shallow groove 84 thereby functioning to guide cutting member 19 along the intended cut line.

While the examples discussed above have been described in connection with what are presently considered to be practical and preferred features, it is to be understood that appended claims are intended to cover modifications and equivalent arrangements included within the spirit and scope of these examples.

What is claimed is:

1. An attachment for a cutting tool, the cutting tool having a cutting member configured to cut an object, the attachment comprising:
a support member configured for attachment to the cutting tool; and
a tracking guide connected to the support member and configured to be in alignment with said cutting member, the tracking guide configured to interface with an object to be cut,
wherein the tracking guide is configured for insertion into a groove previously formed by the cutting member so as to guide further progress of the cutting member.

2. The attachment of claim 1, further comprising a stabilizing bar configured to lie against a surface of the object.

3. The attachment of claim 2, wherein the stabilizing bar is connected to the support member, and the tracking guide protrudes from the stabilizing bar.

4. The attachment of claim 3, wherein the tracking guide has a wedge shape.

5. The attachment of claim 3, wherein the tracking guide extends beyond an edge of the stabilizing bar.

6. The attachment of claim 2, wherein the stabilizing bar forms an angle with the support member, and
wherein the stabilizing bar is arranged such that the angle determines an angle at which the cutting member cuts through the object.

7. The attachment of claim 1, wherein the tracking guide is configured such that movement of the tracking guide within the confines of the groove maintains advancement of the cutting member along a line projected from the previously formed groove.

8. A chainsaw, comprising:
a cutting member to cut an object; and
the attachment of claim 1 connected to the cutting member.

9. The chainsaw of claim 8, further comprising a stabilizing bar configured to lie against a surface of the object,
wherein the stabilizing bar forms an angle with the cutting member, and
wherein the stabilizing bar is arranged such that the angle determines an angle at which the cutting member cuts through the object.

10. A method of cutting through an object with a powered cutting tool having a cutting member to cut the object, the cutting tool including a guide device attached thereto, the guide device comprising a tracking guide, the method comprising:
forming an initial groove in at least part of the object along a defined cut line;
inserting the tracking guide into the previously formed groove;
performing a through-cut in the object by positioning the tracking guide in the groove while performing the through-cut to guide progress of the cutting member during the through-cut.

11. The method of claim 10, wherein the groove is linear and positioning of the tracking guide in the groove while performing the through-cut guides progress of the cutting member during the through-cut.

12. The method of claim 10, wherein the initially cut groove is a shallow groove that is not a through-cut of the object.

13. The method of claim 10, wherein the initially cut groove extends through the object.

14. The method of claim 10, wherein the cutting tool is positioned upside down during the through-cut as compared to the cutting tool position for forming the initial groove.

15. The method of claim 10, wherein the cutting tool is a chainsaw.

16. The method of claim 10, wherein the guide device includes a stabilizing bar configured to lie against a surface of the object, and the tracking guide protrudes from the stabilizing bar.

17. A method of cutting an object with a powered cutting tool having a cutting member to cut the object, the cutting tool including a guide device attached thereto in alignment with the cutting member, the guide device comprising a protruding tracking guide, the method comprising:
cutting the object with the cutting member to form an initial groove in the object along at least part of a defined cut line;
inserting the tracking guide into the initial groove such that movement of the tracking guide within the groove guides advancement of the cutting member along said defined cut line.

18. The method of claim 17, wherein the cutting tool is a chainsaw.

19. An attachment for a chainsaw having a chainsaw bar around which a sawing chain is moved, said attachment comprising:
a mount member configured for affixation to a chainsaw;
a stabilizing bar affixed to said mount member; and
a linear tracking guide protruding from said stabilizing bar in a direction opposite said mount member and configured to extend in parallel to a chainsaw bar of said chainsaw when installed on the chainsaw.

20. The attachment of claim 19, wherein the tracking guide protrudes perpendicularly from said stabilizing bar, and the tracking guide is in alignment with the chainsaw bar of said chainsaw when installed on the chainsaw.
